(19) United States
(12) Patent Application Publication
(10) Pub. No.: US 2026/0166744 A1
(43) Pub. Date: Jun. 18, 2026

(54) Humanoid Robotic Arm with Internal Tool Deployment and Sensor-Fusion Control System

(71) Applicant: Muhammad Jaseem, Houston, TX (US)

(72) Inventor: Muhammad Jaseem, Houston, TX (US)

(21) Appl. No.: 19/356,159

(22) Filed: Oct. 12, 2025

(51) Int. Cl. B25J 9/16; B25J 13/02; B25J 13/08; B25J 15/00; B25J 15/04; B25J 19/00

(52) U.S. Cl. CPC B25J 9/1694; B25J 13/025; B25J 13/081; B25J 13/085; B25J 15/0009; B25J 15/0066; B25J 15/045; B25J 15/0483; B25J 19/0066; B25J 19/0075

(57) ABSTRACT

A humanoid robotic arm and hand assembly featuring an internal tool-deployment mechanism, integrated sensor-fusion system, and intelligent tool-identification interface. The arm includes a forearm cavity housing modular apparatuses such as drills, welders, or other functional tools. A coordinated set of linear actuators lifts the hand into a clearance position and drives a carriage that extends the selected tool through a palm aperture to a docking interface. The docking interface incorporates a USB-C port enabling automatic detection and power/data communication with each tool module. A multi-modal sensor array—including force/torque, vibration, infrared-thermal, orientation, and gas-detection sensors—provides feedback for alignment, safety, and adaptive control. A camera and onboard AI processor monitor the environment and tool activity to ensure precision and self-adjustment. The system enables an intelligent, compact, and self-diagnosing humanoid manipulator capable of autonomous or supervised operation.

### CROSS-REFERENCE TO RELATED APPLICATIONS

This application claims no priority to any previously filed U.S. or foreign patent application.

### FIELD OF THE INVENTION

The present invention relates to robotics and automation, and more particularly to a humanoid robotic arm and hand assembly with integrated sensor fusion, modular tool deployment, and intelligent control systems.

### BACKGROUND OF THE INVENTION

Conventional robotic arms require external tool changers or fixed tool attachments, which limit flexibility and increase bulk. Existing humanoid designs often separate manipulation and tool operation, resulting in complex cabling and reduced efficiency. There is a need for a compact, integrated system allowing a humanoid arm to handle objects naturally while also performing specialized tool-based operations autonomously.

### SUMMARY OF THE INVENTION

The present invention provides a humanoid robotic arm featuring an internal tool-deployment cavity, linear actuator system, and multi-sensor fusion architecture. The system includes USB-C based docking for automated tool identification, AI vision for operational awareness, and interchangeable tool modules enabling a broad range of mechanical, electrical, and industrial applications.

### BRIEF DESCRIPTION OF THE DRAWINGS

FIG. 1 is a general perspective view of the humanoid robotic arm showing the outer structure, hand (100), arm cover (106), and general component placement.

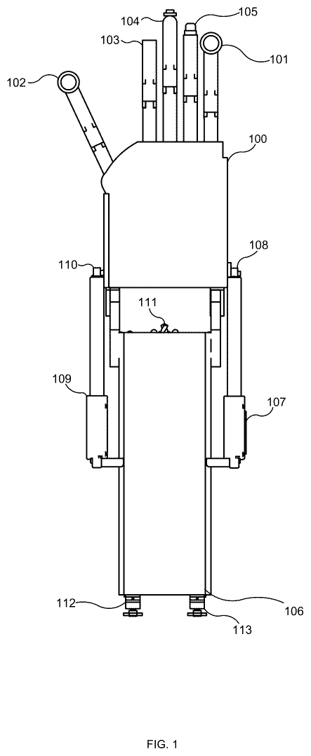

FIG. 2 is a partial internal view of the arm with the outer cover (106) removed to reveal the internal linear actuator (114) that pushes the apparatus in and out of the arm cavity; the view shows the drill apparatus (111) in position.

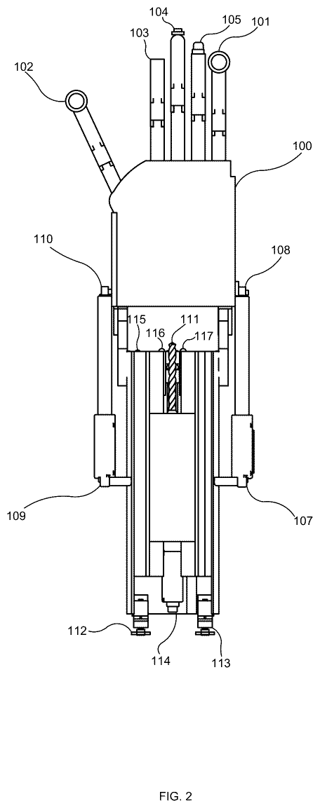

FIG. 3 is a side view of the arm in a raised position with the drill apparatus (111) deployed outward through the palm.

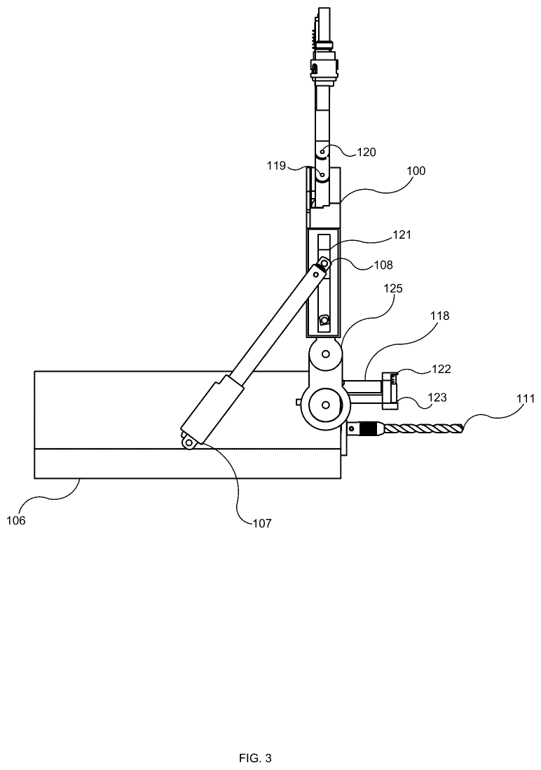

FIG. 4 is a front view of the arm with the hand raised, showing the primary camera (115) and the associated sensors (116, 117, 125, 126) mounted on the hand for environmental monitoring and alignment.

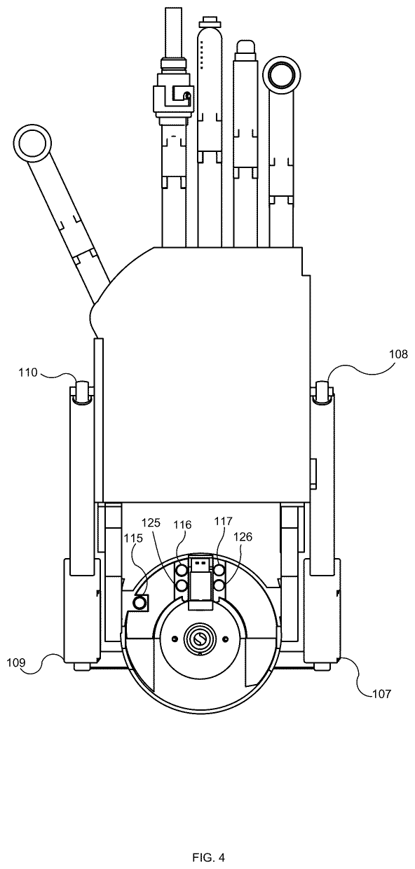

FIG. 5 is a side view illustrating the taser apparatus (127) extending outward from the arm.

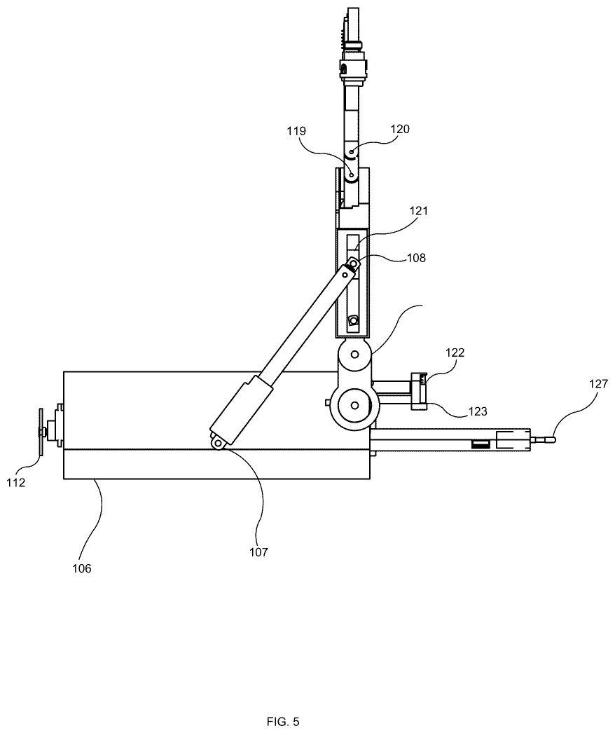

FIG. 6 is a southwest perspective view showing the welding apparatus (128) deployed through the palm aperture.

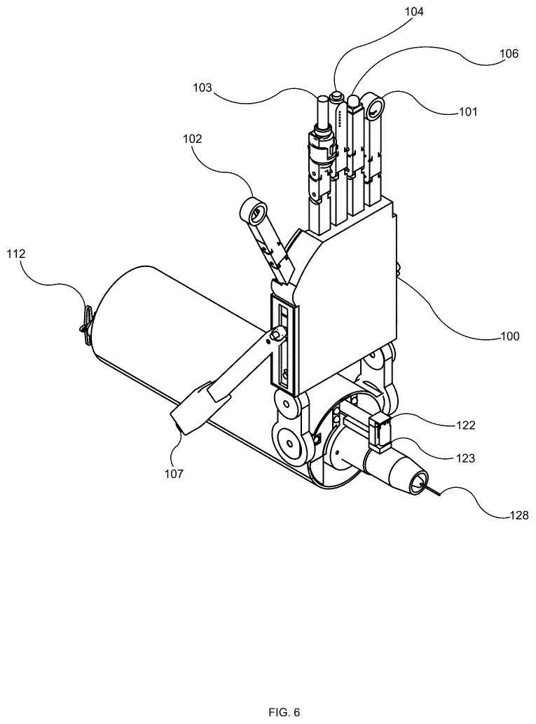

FIG. 7 is a northwest perspective view showing the cleaning brush and vacuum apparatus (129) emerging from the arm cavity.

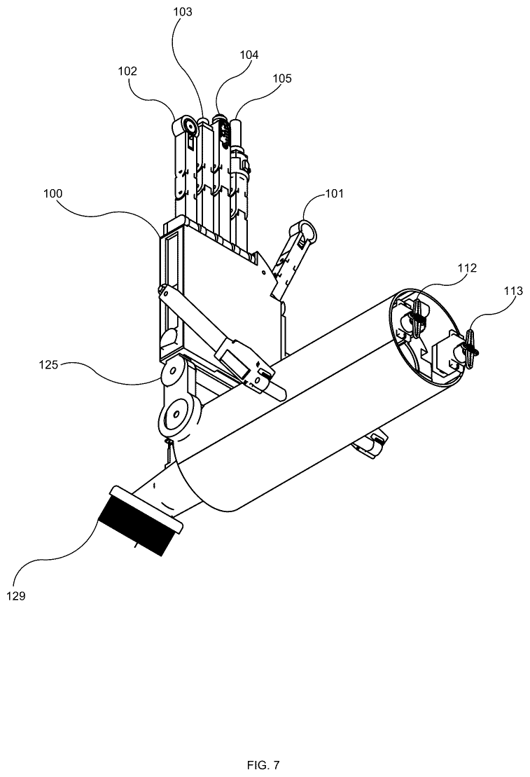

FIG. 8 is a southwest perspective view depicting the arm with the drill machine apparatus (111) deployed.

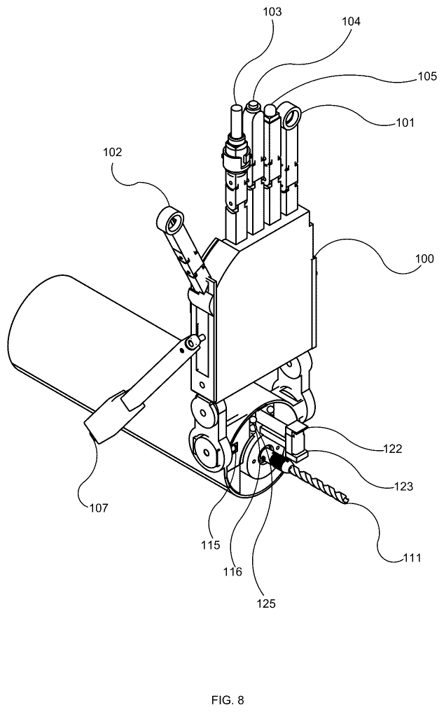

### DETAILED DESCRIPTION OF THE INVENTION

The humanoid arm (100) includes a hand (100) connected via joint (124) to an arm housing (106) containing linear actuators (107, 109, 118) and actuator rods (108, 110). The actuators control the lifting of the hand and the extension of an internal carriage that deploys a selected apparatus (111) through a palm aperture.

Each tool module connects to a USB-C docking interface (122) and adapter (123) allowing automatic tool identification, power supply, and data transfer.

The hand comprises multiple fingers (101-105), including pressure-sensor fingers and modular screw-type adaptor fingers that can be replaced with different functional attachments.

The integrated camera (115), IMU sensor (126), infrared thermal sensor (125), and leveling sensors (116-117) provide environmental awareness.

The gas/fume detector and vibration/acoustic sensors enhance safety during welding or drilling operations.

The arm may include the following interchangeable apparatus modules:
1. Electric drill
2. Electric screwdriver
3. Welding torch
4. Flashlight module
5. Laser range finder
6. Taser/stun module
7. Soldering iron
8. Vacuum/cleaning brush
9. Paint sprayer
10. Hot air blower
11. Camera inspection probe
12. Cutting tool
13. Medical syringe injector
14. Gripper with magnetized tip
15. Miniature polishing buffer
16. Ultrasonic cleaning tool
17. Thermal cutter
18. Cooling fan module
19. Precision scalpel for surgery
20. Temperature/humidity probe
21. Acoustic microphone for sound mapping
22. Sensor calibration probe

All modules share a standardized mechanical interface and electrical connector, allowing rapid tool exchange.

When a module is inserted, the arm's onboard AI identifies it via USB-C signaling and loads corresponding operational parameters.

The linear actuator (114) deploys or retracts the module, while actuator (107) lifts the hand to a 90-degree position to clear the deployment path.

The arm can operate autonomously or under human supervision, using AI models to detect surface alignment, force feedback, and temperature conditions before engaging each operation.

### Alternative Embodiments

In alternative embodiments, the same internal deployment and sensor-fusion system can be adapted for medical robotics, laboratory automation, or hazardous environment handling.

The modular tool cavity can store diagnostic instruments such as injectors, scalers, or sample collectors.

In industrial use, the system can integrate torque tools, cutting blades, or precision welding probes.

For research and humanoid AI applications, the arm can serve as a self-learning manipulator capable of sensing, reacting, and adapting to multiple work environments.

### Advantages of the Invention

1. Compact, self-contained design with integrated tool storage.
2. Sensor-fusion architecture enabling real-time environmental adaptation.
3. USB-C auto-recognition of modular tools for intelligent operation.
4. Reduced need for external tool changers or human intervention.
5. Capable of both delicate manipulation and heavy-duty operations.
6. Easily upgradable and configurable for industrial, research, and medical uses.

1. A humanoid robotic arm comprising: a hand portion coupled to an arm housing by a pivot joint; a cavity within the arm housing configured to store one or more interchangeable apparatus modules; a first linear actuator arranged to move the hand portion into a clearance pose about the pivot joint; a second linear actuator mounted within the cavity and configured to translate a guided carriage on dual linear rails with anti-backdrive between a stowed position and a deployed position through a palm aperture having a retractable cover; a concentric docking interface aligned with the aperture and providing mechanical alignment, power, and data through a USB-C connector configured for automatic identification of the attached apparatus module; an intelligent controller configured to enforce interlocks requiring the clearance pose and open cover prior to deployment; and a sensor-fusion network comprising force/torque, vibration/acoustic, infrared-thermal, inertial measurement, and gas/fume sensors configured to adapt tool operation in real time.

2. The humanoid robotic arm of claim 1, wherein the hand portion includes a plurality of fingers with integrated pressure sensors for adaptive gripping.

3. The humanoid robotic arm of claim 1, wherein at least one finger comprises a modular screw-type connector for interchangeable sensor or tool attachments.

4. The humanoid robotic arm of claim 1, wherein the palm aperture includes a retractable cover or door configured to seal the cavity during non-operation to prevent debris or heat damage.

5. The humanoid robotic arm of claim 1, wherein the first linear actuator is configured to raise the hand approximately 90 degrees prior to tool deployment.

6. The humanoid robotic arm of claim 1, wherein the docking interface includes an alignment collar ensuring mechanical precision of ±0.2 mm during engagement of the apparatus module.

7. The humanoid robotic arm of claim 1, wherein the apparatus modules include at least one selected from the group consisting of: drill, electric screwdriver, welder, flashlight, laser range finder, taser, soldering iron, vacuum brush, paint sprayer, hot air blower, camera probe, cutting tool, medical injector, polishing buffer, ultrasonic cleaner, thermal cutter, cooling fan, scalpel, temperature probe, humidity sensor, microphone, or calibration probe.

8. The humanoid robotic arm of claim 1, wherein the intelligent controller is configured to receive identification data via USB-C protocol and automatically load tool-specific torque, temperature, or safety parameters.

9. The humanoid robotic arm of claim 1, wherein an interlock circuit prevents motion of the carriage unless the hand portion is in the clearance pose and the cover is open.

10. The humanoid robotic arm of claim 1, wherein the vibration/acoustic sensors detect chatter or slip and automatically reduce tool speed or pressure.

11. The humanoid robotic arm of claim 1, further comprising a haptic feedback actuator to signal the operator when the tool contacts a surface or overload occurs.

12. The humanoid robotic arm of claim 1, wherein the gas/fume detector triggers ventilation or system shutdown in the presence of hazardous fumes.

13. The humanoid robotic arm of claim 1, wherein the intelligent controller employs artificial intelligence models to determine optimal actuator parameters based on real-time sensor fusion data.

14. The humanoid robotic arm of claim 1, wherein a safety brake or spring mechanism ensures retraction of the apparatus upon power loss.

15. The humanoid robotic arm of claim 1, wherein the hand remains capable of gripping or stabilizing an object while the internal actuator deploys a tool through the palm.

16. The humanoid robotic arm of claim 1, wherein the system is capable of autonomous operation or manual supervision with wireless communication through the USB-C or network transceiver.

17. The humanoid robotic arm of claim 1, wherein the arm is mountable to a humanoid torso via servo joints allowing full limb articulation.

18. The humanoid robotic arm of claim 1, wherein the controller records operation data for predictive maintenance and self-diagnostic purposes.

19. The humanoid robotic arm of claim 1, wherein the carriage assembly includes a thermal shield for heat-producing modules such as welders or cutters.

20. The humanoid robotic arm of claim 1, further comprising a control subsystem configured to: (a) identify a connected apparatus module through a USB-C docking interface; (b) verify that the hand portion is positioned in a clearance pose and the palm cover is open; (c) activate the second linear actuator to deploy or retract the apparatus module through the palm aperture; (d) collect and process sensor data from a sensor-fusion network including force/torque, vibration, infrared, inertial, and gas/fume sensors;
and(e) dynamically adjust actuator and tool parameters based on artificial-intelligence models stored in memory to maintain safe and optimized operation; wherein the subsystem executes these steps automatically through embedded firmware or computer-executable instructions stored on a non-transitory medium within the controller.
